(19) United States
(12) Patent Application Publication
(10) Pub. No.: US 2020/0147533 A1
(43) Pub. Date: May 14, 2020

(54) USE OF CARBOXYLIC ACID POLYMER AS VAPOR ALCOHOL REMOVING MATERIAL AND FILTER MESH STRUCTURE FOR REMOVING VAPOR ALCOHOL

(71) Applicant: GREENFILTEC TAIWAN LTD., Hsinchu City (TW)

(72) Inventor: Yi-Hui YU, Hsinchu City (TW)

(73) Assignee: GREENFILTEC TAIWAN LTD., Hsinchu City (TW)

(21) Appl. No.: 16/453,427

(22) Filed: Jun. 26, 2019

(30) Foreign Application Priority Data
Nov. 12, 2018 (TW) 107140093

(51) Int. Cl. B01D 39/16; B01J 20/26; B01D 35/02

(52) U.S. Cl. CPC B01D 39/16; B01J 20/261; B01D 35/02; B01D 2239/0407; B01D 2253/202; B01D 2258/06; B01D 2257/70; B01D 2201/31

(57) ABSTRACT

Use of a carboxylic acid polymer as a vapor alcohol removing material and a filter mesh structure for removing vapor alcohol are provided. The filter mesh structure for removing vapor alcohol includes a first filter mesh, a second filter mesh, and a vapor alcohol removing material. The first filter mesh has a first side face. The second filter mesh having a second side face is disposed on one side of the first filter mesh, so that the second side face faces the first side face. The vapor alcohol removing material is disposed between the first filter mesh and the second filter mesh. The vapor alcohol removing material includes a carboxylic acid polymer.

### BACKGROUND

### Technical Field

The present invention relates to use of a carboxylic acid polymer as a vapor alcohol removing material and a filter mesh structure for removing vapor alcohol.

### Related Art

In the field of industrial manufacturing such as semiconductor manufacturing, a clean room is used widely to enable the production and manufacture of products in a clean and pollution-free isolated environment, so as to further improve the product yield.

To meet the environmental requirements for a clean room, a fan and a filter device are typically provided at the air intake of the clean room to drive the airflow by the fan to flow through the filter mesh of the filter device into the clean room, whereby dusts and various pollutions both organic and inorganic are filtered out.

Among the pollutions, vapor alcohol, which does not have a fixed shape like dusts, is incapable of being filtered out by controlling the size of the holes in the filter mesh. Common activated carbons provide poor removal of low-concentration vapor alcohol. Therefore, it remains as a problem to be solved to remove effectively low-concentration vapor alcohol.

### SUMMARY

The primary object of the present invention is to provide use of a carboxylic acid polymer as a vapor alcohol removing material.

Another object of the present invention is to provide a filter mesh structure for removing vapor alcohol.

In the use of a carboxylic acid polymer as a vapor alcohol removing material of the present invention, the carbon number in the monomer of the carboxylic acid polymer is less than 7.

In an embodiment of the present invention, the carboxylic acid polymer further includes an amino group (—NH₂).

In an embodiment of the present invention, the carboxylic acid polymer is one selected from the group consisting of poly(methyl vinyl ether-alt-maleic acid), poly(acrylic acid-co-maleic acid), poly(acrylic acid), poly(methacrylic acid), poly(maleic acid), poly acrylamide-co-acrylic acid, poly(ethylene-co-acrylic acid), and poly(ethylene-co-methacrylic acid), or a combination thereof.

The filter mesh structure for removing vapor alcohol of the present invention includes a first filter mesh, a second filter mesh, and a vapor alcohol removing material. The first filter mesh has a first side face. The second filter mesh having a second side face is disposed on one side of the first filter mesh, so that the second side face faces the first side face. The alcohol removing material is disposed between the first filter mesh and the second filter mesh. The alcohol removing material includes a carboxylic acid polymer.

In an embodiment of the present invention, the vapor alcohol removing material is disposed between the first filter mesh and the second filter mesh in the amount of 600 to 800 g/m².

### BRIEF DESCRIPTION OF THE DRAWINGS

FIG. 1 is a schematic view of a filter mesh structure for removing vapor alcohol according to an embodiment of the present invention;

FIG. 2 is a graph showing the results of a gas adsorption test on various vapor alcohol removing material samples according to the present invention; and

FIG. 3 is a graph showing the results of a gas adsorption test on a vapor alcohol removing material disposed in various amounts according to the present invention.

### DETAILED DESCRIPTION

The polymers of carboxylic acid (having a general formula of R—COOH) according to the present invention are used as a vapor alcohol removing material. The alcohol includes, but is not limited to, ethanol, isobutanol, and isopropanol.

In an example, the carbon number in the monomer of the carboxylic acid polymer is less than 7, but is not limited thereto. In another example, the carboxylic acid polymer further includes amino (—NH₂). More particularly, in an example, the carboxylic acid polymer is one selected from the group consisting of poly(methyl vinyl ether-alt-maleic acid), poly(acrylic acid-co-maleic acid), poly(acrylic acid), poly(methacrylic acid), poly(maleic acid), poly acrylamide-co-acrylic acid, poly(ethylene-co-acrylic acid), and poly(ethylene-co-methacrylic acid), or a combination thereof.

Further, a carboxyl group is composed of a hydroxyl group capable of generating a hydrogen bond and a carbonyl group, and thus has a polarity. By virtue of this polarity, the alcohol substance can be adsorbed and thus removed from the target product, thereby achieving the effect of removing the vapor alcohol. For example, a vapor alcohol removing material is disposed in a filter mesh structure, so that the vapor alcohol compounds in the gas passing through this filter mesh can be removed.

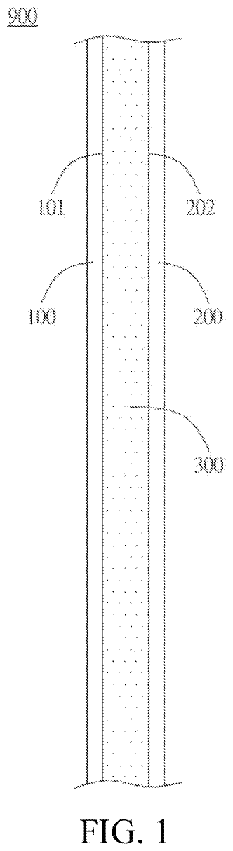

In the example shown in FIG. 1, the filter mesh structure 900 for removing the vapor alcohol of the present invention includes a first filter mesh 100, a second filter mesh 200, and a vapor alcohol removing material 300. The first filter mesh 100 has a first side face 101. The second filter mesh 200 having a second side face 202 is disposed on one side of the first filter mesh 100, so that the second side face 202 faces the first side face 101. The first filter mesh 100 and the second filter mesh 200 may be made of a material such as polyethylene terephthalate (PET), polypropylene (PP), and the like and has a hole size of 50 to 60 meshes.

The alcohol removing material 300 is disposed between the first filter mesh 100 and the second filter mesh 200. The alcohol removing material 300 includes a carboxylic acid polymer. More particularly, in an example, the vapor alcohol removing material 300 is disposed between the first filter mesh 100 and the second filter mesh 200 in an amount of 600 to 800 g/m². The vapor alcohol removing material has a diameter of 30 to 60 meshes. There is a pressure difference of 20 to 30 Pa between opposite sides of the first filter mesh 100 and the second filter mesh 200 (i.e., the two outer sides of the filter mesh structure 900 are opposite to each other).

In an example, non-woven fabric is used as the first filter mesh and the second filter mesh respectively, and various vapor alcohol removing material samples are provided and disposed between the first filter mesh and the second filter mesh in an amount of 600 g/m². The carboxylic acid polymer contained in the vapor alcohol removing material is shown in Table 1.

TABLE 1

| | |
|---|---|
| Sample 1 | poly(methyl vinyl ether-alt-maleic acid) |
| Sample 2 | poly(acrylic acid-co-maleic acid) |
| Sample 3 | poly(acrylic acid) |
| Sample 4 | poly(methacrylic acid) |
| Sample 5 | poly(maleic acid) |
| Sample 6 | poly(acrylamide-co-acrylic acid) |
| Sample 7 | poly(ethylene-co-acrylic acid) |
| Sample 8 | poly(ethylene-co-methacrylic acid) |

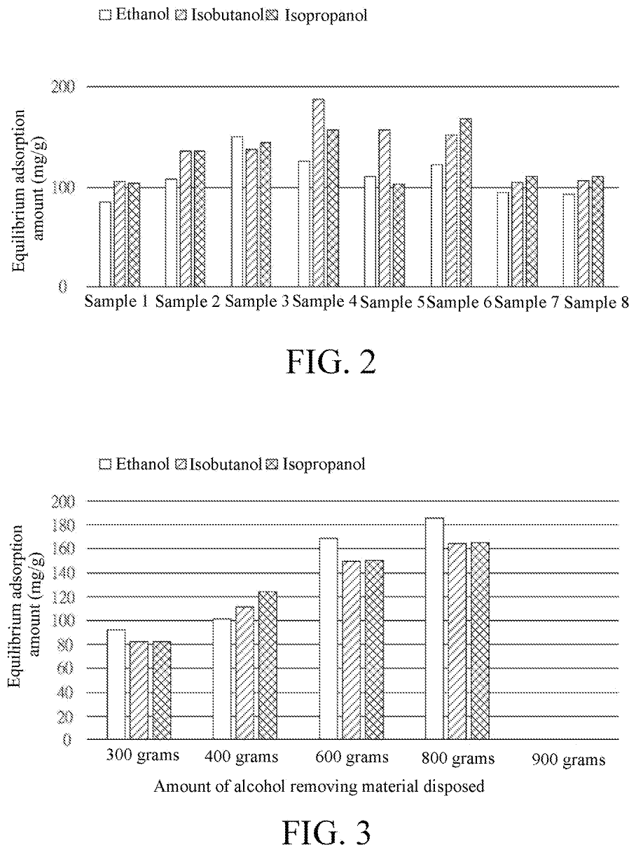

Thereafter, ethanol, isobutanol, and isopropanol at a concentration of 100 μg/m³ as test gases are passed through the filter mesh structure. By using a gas chromatograph (SHIMADZU GCMS-QP2020, Japan), a thermal desorber (MARKES Thermal Desorber UNITY-xr) and 1000 μg/m³ toluene as a semi-quantitative standard, the outlet concentration is continuously measured to calculate the equilibrium adsorption amount, that is, milligrams of test gas absorbed per gram of vapor alcohol removal material. The test results are shown in Table 2 and FIG. 2.

TABLE 2

| Material between the | Equilibrium | Equilibrium | Equilibrium |
|---|---|---|---|
| first and second filter | adsorption amount | adsorption amount | adsorption amount |
| meshes | of ethanol (mg/g) | of isobutanol (mg/g) | of isopropanol (mg/g) |
| Activated carbon | 35 | 47 | 43 |
| Sample 1 | 84.7 | 105.8 | 103.72 |
| Sample 2 | 108.4 | 135.5 | 135.5 |
| Sample 3 | 150 | 138.5 | 144.25 |
| Sample 4 | 125.4 | 187.5 | 156.45 |
| Sample 5 | 110.8 | 156.75 | 102.425 |
| Sample 6 | 122 | 152.5 | 167.75 |
| Sample 7 | 94.6 | 104.8 | 110.18 |
| Sample 8 | 92.5 | 106.4 | 110.09 |

As seen from the results shown in Table 2 and FIG. 2, the filter mesh structure for removing vapor alcohol of the present invention utilizes a vapor alcohol removing material containing a carboxylic acid polymer which has a desirable adsorption effect for vapor alcohol and thus enables effective removal of vapor alcohol.

In an example, non-woven fabric is used as the first filter mesh and second filter mesh respectively, and a vapor alcohol removing material containing poly(acrylic acid) of various weights is provided and disposed between the first filter mesh and the second filter mesh. Thereafter, ethanol, isobutanol, and isopropanol at a concentration of 100 μg/m³ as test gases are passed through the filter mesh structure respectively. By using a gas chromatograph (SHIMADZU GCMS-QP2020, Japan), a thermal desorber (MARKES Thermal Desorber UNITY-xr) and 1000 μg/m³ toluene as a semi-quantitative standard, the outlet concentration is continuously measured to calculate the equilibrium adsorption amount, that is, milligrams of test gas absorbed per gram of vapor alcohol removal material. The test results are shown in Table 3 and FIG. 3.

TABLE 3

| Amount of vapor | Equilibrium | Equilibrium | Equilibrium |
|---|---|---|---|
| alcohol removing | adsorption amount | adsorption amount | adsorption amount |
| material disposed | of ethanol (mg/g) | of isobutanol (mg/g) | of isopropanol (mg/g) |
| 300 g/m² | 92.5 | 82.2 | 82.6 |
| 400 g/m² | 102 | 112 | 124 |
| 600 g/m² | 169 | 149.5 | 150.2 |
| 800 g/m² | 185.9 | 164.5 | 165.2 |
| 900 g/m² | NA | NA | NA |

In an example, non-woven fabric is used as the first filter mesh and second filter mesh respectively, and a vapor alcohol removing material containing poly(acrylic acid) of various weights is disposed between the first filter mesh and the second filter mesh. Thereafter, ethanol, isobutanol, and isopropanol at a concentration of 100 μg/m³ as test gases are passed through the filter mesh structure respectively. By using a gas chromatograph (SHIMADZU GCMS-QP2020, Japan), a thermal desorber (MARKES Thermal Desorber UNITY-xr) and 1000 μg/m³ toluene as a semi-quantitative standard, the outlet concentration is continuously measured to calculate the equilibrium adsorption amount, that is, milligrams of test gas absorbed per gram of vapor alcohol removal material. The test results are shown in Table 4.

TABLE 4

| Amount of vapor | Equilibrium | Equilibrium | Equilibrium |
|---|---|---|---|
| alcohol removing | adsorption amount | adsorption amount | adsorption amount |
| material disposed | of ethanol (mg/g) | of isobutanol (mg/g) | of isopropanol (mg/g) |
| 300 g/m² | 93.8 | 92.7 | 88.5 |
| 400 g/m² | 98.6 | 112.9 | 105 |
| 600 g/m² | 133.1 | 152.9 | 157.3 |
| 800 g/m² | 145.8 | 166.5 | 171.5 |
| 900 g/m² | NA | NA | NA |

As seen from the results shown in Table 3 and FIGS. 3 and 4, in the filter mesh structure for removing vapor alcohol of the present invention, the amount of the vapor alcohol removing material disposed between the first filter mesh and the second filter mesh is preferably 600 to 800 g/m².

The foregoing description and drawings have disclosed the preferred embodiments of the present invention. However, it is appreciated that various additions and many modifications and replacements can be made to the preferred embodiments of the present invention without departing from the spirit and scope of the present invention which is to be defined by the following claims. Many modifications of forms, structures, arrangements, ratios, materials, elements and components can be made by those skilled in the art to which the present invention pertains. Therefore, the embodiments disclosed herein are to be considered as illustrating and not limiting the present invention. The scope of the present invention is defined by the following claims, encompassing the legal equivalents thereof, and are not limited to the foregoing description.

What is claimed is:

1. Use of a carboxylic acid polymer as a vapor alcohol removing material.

2. The use of claim 1, wherein the carbon number in the monomer of the carboxylic acid polymer is less than 7.

3. The use of claim 1, wherein the carboxylic acid polymer further includes an amino group (—NH₂).

4. The use of claim 1, wherein the carboxylic acid polymer is one selected from the group consisting of poly(methyl vinyl ether-alt-maleic acid), poly(acrylic acid-co-maleic acid), poly(acrylic acid), poly(methacrylic acid), poly(maleic acid), poly acrylamide-co-acrylic acid, poly(ethylene-co-acrylic acid), and poly(ethylene-co-methacrylic acid), or a combination thereof.

5. A filter mesh structure for removing vapor alcohol, comprising:
a first filter mesh having a first side face;
a second filter mesh having a second side face and disposed on one side of the first filter mesh, so that the second side face faces the first side face; and
a vapor alcohol removing material disposed between the first filter mesh and the second filter mesh, the alcohol removing material including a carboxylic acid polymer.

6. The filter mesh structure of claim 5, wherein the vapor alcohol removing material is disposed between the first filter mesh and the second filter mesh in the amount of 600 to 800 g/m².

7. The filter mesh structure of claim 5, wherein the carbon number in the monomer of the carboxylic acid polymer is less than 7.

8. The filter mesh structure of claim 5, wherein the carboxylic acid polymer further includes an amino group (—NH₂).

9. The filter mesh structure of claim 5, wherein the carboxylic acid polymer is one selected from the group consisting of poly(methyl vinyl ether-alt-maleic acid), poly(acrylic acid-co-maleic acid), poly(acrylic acid), poly(methacrylic acid), poly(maleic acid), poly acrylamide-co-acrylic acid, poly(ethylene-co-acrylic acid), and poly(ethylene-co-methacrylic acid), or a combination thereof.
